(19) United States
(12) Patent Application Publication
(10) Pub. No.: US 2005/0241542 A1
(43) Pub. Date: Nov. 3, 2005

(54) Cement-based systems using water retention agents prepared from raw cotton linters

(76) Inventors: Wolfgang Hagen, Meerbusch (DE); Wolfgang Hildebrandt, Dinslaken (DE); Wilfried Hohn, Erftstadt (DE); Dieter Schweizer, Duesseldorf (DE)

Correspondence Address: Hercules Incorporated;Hercules Plaza, 1313 North Market Street, Wilmington, DE, 19894-0001, US

(21) Appl. No.: 11/114,479

(22) Filed: Apr. 26, 2005

Related U.S. Application Data
(60) Provisional application No. 60/565,643, filed on Apr. 27, 2004.

(51) Int. Cl. C04B 14/00

(52) U.S. Cl. 106/805

(57) ABSTRACT

A mixture composition of a cellulose ether made from raw cotton linters and at least one additive is used in a cement based dry mortar composition wherein the amount of the cellulose ether in the tile cement based dry mortar composition is significantly reduced. When this cement based mortar dry composition is mixed with water and applied to a substrate, the water retention, thickening behavior, and/or sag resistance of the wet mortar are comparable or improved as compared to when using conventional similar cellulose ethers.

This application claims the benefit of U.S. Provisional Application No. 60/565,643, filed Apr. 27, 2004

### FIELD OF THE INVENTION

This invention relates to a mixture composition useful in cement based dry mortar compositions as mortars for building walls and other objects. More specifically, this invention relates to a cement based dry mortar for use in thin joint mortar and masonry mortar using an improved water retention agent of a cellulose ether that is prepared from raw cotton linters.

### BACKGROUND OF THE INVENTION

Traditional cement-based mortars, like e.g. traditional masonry mortar, are often simple mixtures of cement and sand. The dry mixture is mixed with water to form a mortar. These traditional mortars, per se, have poor fluidity or trowelability. Consequently, the application of these mortars is labor intensive, especially in summer months under hot weather conditions, because of the rapid evaporation or removal of water from the mortar, which results in inferior or poor workability as well insufficient hydration of cement.

The physical characteristics of a hardened traditional mortar are strongly influenced by its hydration process, and thus, by the rate of water removal therefrom during the setting operation. Any influence, which affects these parameters by increasing the rate of water removal or by diminishing the water concentration in the mortar at the onset of the setting reaction, can cause a deterioration of the physical properties of the mortar. Many substrates, such as lime sandstone, cinderblock, wood or foam mortar stones are porous and able to remove a significant amount of water from the mortar leading to the difficulties just mentioned.

To overcome, or to minimize, the above mentioned water-loss problems, the prior art discloses uses of cellulose ethers as water retention agents to mitigate this problem. An example of this prior art is U.S Pat. No. 4,501,617 that discloses the use of hydroxypropylhydroxyethylcellulose (HPHEC) as a water retention aid for improving trowellability or fluidity of mortar. The uses of cellulose ether in dry-mortar applications are disclosed in prior art patents, such as DE 3046585, EP 54175, DE 3909070, DE3913518, CA2456793, EP 773198.

German publication 4,034,709 A1 discloses the use of raw cotton linters to prepare cellulose ethers as additives to cement based hydraulic mortars or concrete compositions.

Cellulose ethers (CEs) represent an important class of commercially important water-soluble polymers. These CEs are capable of increasing viscosity of aqueous media. This viscosifying ability of a CE is primarily controlled by its molecular weight, chemical substituents attached to it, and conformational characteristics of the polymer chain. CEs are used in many applications, such as construction, paints, food, personal care, pharmaceuticals, adhesives, detergents/cleaning products, oilfield, paper industry, ceramics, polymerization processes, leather industry, and textiles.

Methylcellulose (MC), methylhydroxyethylcellulose (MHEC), ethylhydroxyethylcellulose (EHEC), methylhydroxypropylcellulose (MHPC), hydroxyethylcellulose (HEC), and hydrophobically modified hydroxyethylcellulose (HMHEC) either alone or in combination are most widely used for dry mortar formulations in the construction industry. By a dry mortar formulation is meant a blend of gypsum, cement, and/or lime as the inorganic binder used either alone or in combination with aggregates (e.g., silica and/or carbonate sand/powder), and additives.

For their use, these dry mortars are mixed with water and, applied as wet materials. For the intended applications, water-soluble polymers that give high viscosity upon dissolution in water are required. By using MC, MHEC, MHPC, EHEC, HEC, or HMHEC or combinations thereof, desired dry mortars (i.e., masonry mortar and thin joint mortar,) properties such as high water retention (and consequently a defined control of water content) are achieved. Additionally, an improved workability and satisfactory adhesion of the resulting material can be observed. Since an increase in CE solution viscosity results in improved water retention capability and adhesion, high molecular weight CEs are desirable in order to work more efficiently and cost effectively. In order to achieve high solution viscosity, the starting cellulose ether has to be selected carefully. Currently, by using purified cotton linters or high viscosity wood pulps, the highest 2 wt % aqueous solution viscosity that can be achieved is about 70,000-80,000 mPas (using Brookfield RVT viscometer at 20° C. and 20 rpm, using spindle number 7).

A need still exist in the cement-based dry mortars industry for having a water retention agent that can be used in a cost effective manner to improve the application and performance properties of cement based plasters. In order to assist in achieving this result, it would be preferred to provide a water retention agent that provides an aqueous Brookfield solution viscosity of preferably greater than about 80,000 mPas at 2 wt % concentration and still be cost effective for use as a thickener and/or water retention agent.

### SUMMARY OF THE INVENTION

The present invention relates to a mixture composition for use in cement-based dry mortar composition of a cellulose either in an amount of 20 to 99.9 wt % of alkylhydroxyalkylcelluloses and hydroxyalkylcelluloses, and mixtures thereof, prepared from raw cotton linters, and at least one additive in an amount of 0.1 to 80 wt % of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres; the mixture composition, when used in a cement based dry mortar composition and mixed with a sufficient amount of water, produces a mortar, which can be applied on substrates wherein the amount of the mixture composition in the mortar composition is significantly reduced while water retention and thickening behavior of the resulting wet mortar are improved or comparable as compared to when using conventional similar cellulose ethers.

The present invention, also, is directed to a cement based dry-mortar composition of a hydraulic cement, fine aggregate material, and water-retaining agent of at least one cellulose ether prepared from raw cotton linters.

When the cement based dry mortar composition is mixed with a sufficient amount of water, it produces a mortar wherein the amount of the cellulose ether is significantly reduced while water retention, thickening and/or sag resistance of the wet mortars are improved or comparable as compared to when using conventional similar cellulose ethers.

### BRIEF DESCRIPTION OF THE DRAWING

FIG. 1 is a graphical representation of the experimental data set forth in Example 3, infra.

FIG. 2 is a graphical representation of the experimental data set forth in Example 4, infra.

FIG. 3 is a graphical representation of the experimental data set forth in Example 6, infra.

### DETAILED DESCRIPTION OF THE INVENTION

It has been found that certain cellulose ethers, particularly, alkylhydroxyalkylcelluloses and hydroxyalkylcelluloses, made from raw cotton linters (RCL) have unusually high solution viscosity relative to the viscosity of conventional, commercial cellulose ethers made from purified cotton linters or high viscosity wood pulps. The use of these cellulose ethers in cement based mortar compositions provide several advantages (i.e., lower cost in use and better application properties) and improved performance properties that were hitherto not possible to achieve using conventional cellulose ethers.

According to European Norm EN 998-2, a masonry mortar is defined as a mix of one or more inorganic binders, aggregates, additives and/or admixtures, used for laying masonry units. It can be “thick” or “thin” layer.

Thin joint mortars are used as a kind of glue for building up walls or other objects using aerated concrete bricks or lime sandstone units.

In accordance with this invention, cellulose ethers of alkylhydroxyalkylcelluloses and hydroxyalkylcelluloses are prepared from cut or uncut raw cofton linters. The alkyl group of the alkylhydroxyalkylcelluloses has 1 to 24 carbon atoms and the hydroxyalkyl group has 2 to 4 carbon atoms. Also, the hydroxyalkyl group of the hydroxyalkylcelluloses has 2 to 4 carbon atoms. These cellulose ethers provided unexpected and surprising benefits to the cement based mortars. Because of the extremely high viscosity of the RCL-based CEs, efficient application performance in masonry mortar and thin joint mortar could be observed. Even at lower use level of the RCL based CEs as compared to currently used high viscosity commercial CEs, similar or improved application performance with respect to water is achieved. It could also be demonstrated that alkylhydroxyalkylcelluloses and hydroxyalkylcelluloses, such as methylhydroxyethylcelluloses, methylhydroxypropylcelluloses, hydroxyethylcelluloses, and hydrophobically modified hydroxyethylcelluloses, prepared from RCL give significant body to the mortars.

In accordance with the present invention, the mixture composition has an amount of the cellulose ether of 20 to 99.9 wt %, preferably 70 to 99.0 wt %.

The RCL based water-soluble, nonionic CEs of the present invention include (as primary CEs), particularly, alkylhydroxyalkylcelluloses and hydroxyalkylcelluloses made from raw cotton linters (RCL). Examples of such derivatives include methylhydroxyethylcelluloses (MHEC), methylhydroxypropylcelluloses (MHPC), methylethylhydroxyethylcelluloses (MEHEC), ethylhydroxyethylcelluloses (EHEC), hydrophobically modified ethylhydroxyethylcelluloses (HMEHEC), hydroxyethylcelluloses (HEC), and hydrophobically modified hydroxyethylcelluloses (HMHEC), and mixtures thereof. The hydrophobic substitutents can have 1 to 25 carbon atoms. Depending on their chemical composition, they can have, where applicable, a methyl or ethyl degree of substitution (DS) of 0.5 to 2.5, a hydroxyalkyl molar substitution (HA-MS) of about 0.01 to 6, and a hydrophobic substituent molar substitution (HS-MS) of about 0.01 to 0.5 per anhydroglucose unit. More particularly, the present invention relates to the use of these water-soluble, nonionic CEs as efficient thickeners and/or water retention agents in masonry mortar and thin joint mortar.

In practicing the present invention, conventional CEs made from purified cotton linters and wood pulps (secondary CEs) can be used in combination with RCL based CEs. The preparation of various types of CEs from purified celluloses is known in the art. These secondary CEs can be used in combination with the primary RCL-CEs for practicing the present invention. These secondary CEs will be referred to in this application as conventional CEs because most of them are commercial products or known in the marketplace and/or literature.

Examples of the secondary CEs are methylcellulose (MC), methylhydroxyethylcellulose (MHEC), methylhydroxypropylcellulose (MHPC), hydroxyethylcellulose (HEC), ethylhydroxyethylcellulose (EHEC), methylethylhydroxyethylcellulose (MEHEC), hydrophobically modified ethylhydroxyethylcelluloses (HMEHEC), hydrophobically modified hydroxyethylcelluloses (HMHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

In accordance with the present invention, one preferred embodiment makes use of MHEC and MHPC having an aqueous Brookfield solution viscosity of greater than 80,0000 mPas, preferably of greater than 90,000 mpas, as measured on a Brookfield RVT viscometer at 20° C. and 20 rpm, and a concentration of 2 wt % using spindle no. 7.

In accordance with the present invention, another preferred embodiment makes use of the hydrophobically modified hydroxyethylcellulose that has an aqueous Brookfield solution viscosity of greater than 15,000 mPas as measured on a Brookfield LVF rotational viscometer at 25° C. and 30 rpm, and a concentrating of 2 wt % using spindle number 4.

In accordance with the present invention, the mixture composition has an amount of at least one additive of between 0.1 and 80 wt %, preferably between 0.5 and 30 wt %. Examples of the additives are organic or inorganic thickening agents and/or secondary water retention agents, anti-sag agents, air entraining agents, wetting agents, defoamers, superplasticizers, dispersants, calcium-complexing agents, retarders, accelerators, water repellants, redispersible powders, biopolymers, and fibres. An example of the organic thickening agent is polysaccharides. Other examples of additives are calcium chelating agents, fruit acids, and surface active agents.

More specific examples of the additives are homo- or co- polymers of acrylamide. Examples of such polymers are polyacrylamide, poly(acrylamide-co-sodium acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyldimethylammonium chloride), poly(acrylamide-co-(acryloylamino)propyltrimethylammoniumchloride), poly(acrylamide-co-(acryloyl)ethyltrimethylammoniumchloride), and mixtures thereof.

Examples of the polysaccharide additives are starch ether, starch, guar, guar derivatives, dextran, chitin, chitosan, xylan, xanthan gum, welan gum, gellan gum, mannan, galactan, glucan, arabinoxylan, alginate, and cellulose fibres.

Other specific examples of the additives are gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylateether, polystyrene sulphonates, phosphates, phosphonates, calcium-salts of organic acids having 1 to 4 carbon atoms, , salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

The mixture compositions of this invention can be prepared by a wide variety of techniques known in the prior art. Examples include simple dry blending, spraying of solutions or melts onto dry materials, co-extrusion, or co-grinding.

In accordance with the present invention, the mixture composition when used in a dry cement based mortar formulation and mixed with a sufficient amount of water to produce a mortar, the amount of the mixture, and consequently the cellulose ether, is significantly reduced. The reduction of the mixture or cellulose ether is at least 5%, preferably at least 10%. Even with such reductions in the CE, the water retention and thickening and/or sag-resistance of the wet plaster mortar are comparable or improved as compared to when using conventional similar cellulose ethers.

The mixture composition of the present invention can be marketed directly or indirectly to cement based mortar manufacturers who can use such mixtures directly into their manufacturing facilities. The mixture composition can also be custom blended to preferred requirements of different manufacturers.

The cement based mortar composition of the present invention has an amount of CE of from about 0.001 to 1.0 wt %. The amount of the at least one additive is from about 0.0001 to 10 wt %. These weight percentages are based on the total dry weight of all of the ingredients of the dry cement based mortar composition.

In accordance with the present invention, the dry cement based mortar compositions have aggregate material present in the amount of 10-95 wt %, preferably in the amount of 30-80 wt %. Examples of the aggregate material are silica sand, dolomite, limestone, lightweight aggregates (e.g. expanded polystyrene, hollow glass spheres, perlite, cork, expanded vermiculites), rubber crumbs (recycled from car tires)), and fly ash. By “fine” is meant that the aggregate materials have particle sizes up to 2.0 mm, preferably 1.0 mm.

In accordance with the present invention, the hydraulic cement component is present in the amount of 4-60 wt %, and preferably in the amount of 10-40 wt %. Examples of the hydraulic cement are Portland cement, Portland-slag cement, Portland-silica fume cement, Portland-pozzolana cement, Portland-burnt shale cement, Portland-limestone cement, Portland-composite cement, blastfurnace cement, pozzolana cement, composite cement and calcium aluminate cement.

In accordance with the present invention, the cement-based dry mortar composition has an amount of at least one mineral binder of between 4 and 60 wt %, preferably between 10 and 40 wt %. Examples of the at least one mineral binder are cement, pozzolana, blast furnace slag, hydrated lime, gypsum, and hydraulic lime.

In accordance with a preferred embodiment of the present invention, cellulose ethers are prepared according to U.S. patent application Ser. No. 10/822,926, filed Apr. 13, 2004, which is herein incorporated by reference. The starting material of the present invention is a mass of unpurified raw cotton linter fibers that has a bulk density of at least 8 grams per 100 ml. At least 50 wt % of the fibers in this mass have an average length that passes through a US sieve screen size number 10 (2 mm openings). This mass of unpurified raw cotton linters is prepared by obtaining a loose mass of first cut, second cut, third cut and/or mill run unpurified, natural, raw cotton linters or mixtures thereof containing at least 60% cellulose as measured by AOCS Official Method Bb 3-47 and commuting the loose mass to a length wherein at least 50 wt % of the fibers pass through a US standard sieve size no. 10. The cellulose ether derivatives are prepared using the above mentioned comminuted mass of raw cotton linter fibers as the starting material. The cut mass of raw cotton linters are first treated with a base in a slurry or high solids process as a cellulose concentration of greater than 9 wt % to form an activated cellulose slurry. Then, the activated cellulose slurry is reacted for a sufficient time and at a sufficient temperature with an etherifying agent to form the cellulose ether derivative, which is then recovered. The modification of the above process to prepare the various CEs of the present invention is well known in the art.

The CEs of this invention can also be prepared from uncut raw cotton linters that are obtained in bales of the RCL that are either first, second, third cut, and/or mill run from the manufacturer.

Raw cotton linters including compositions resulting from mechanical cleaning of raw cotton linters, which are substantially free of non-cellulosic foreign matter, such as field trash, debris, seed hulls, etc., can also be used to prepare cellulose ethers of the present invention. Mechanical cleaning techniques of raw cotton linters, including those involving beating, screening, and air separation techniques, are well known to those skilled in the art. Using a combination of mechanical beating techniques and air separation techniques fibers are separated from debris by taking advantages of the density difference between fibers and debris. A mixture of mechanically cleaned raw cotton linters and “as is” raw cotton linters can also be used to manufacture cellulose ethers.

When compared with the masonry and thin joint mortar prepared with conventional cellulose ethers, the mortars of this invention are comparable or improved in thickening behavior and/or sag resistance and water retention, which are important parameters used widely in the art to characterize these cement-based mortars.

According to European Norm EN 1015-8 water retention and/or water retentivity is “the ability of a fresh hydraulic mortar to retain its mixing water when exposed to substrate suction”. It can be measured according to the European Norm EN 18555.

In European Norm EN 1015-3 for masonry mortars the consistency is defined as the fluidity of a fresh mortar.

Typical masonry mortar and thin joint mortar materials may contain some or all of the following components:

TABLE A
Typical Prior Art Composition of different cement-based mortars

| | | Typical amount | |
|---|---|---|---|
| | | Thin | |
| | | joint | Masonry |
| Component | Examples | mortar | mortar |
| Cement | CEM I (Portland cement), CEM | 20-60% | 4-50% |
| | II, CEM III (blast-furnace | | |
| | cement), CEM IV (pozzolana | | |
| | cement), CEM V (composite | | |
| | cement), CAC (calcium aluminate | | |
| | cement) | | |
| Other | Hydrated lime, gypsum, | 0-10% | 0-30% |
| mineral | puzzolana, blast furnace slag, | | |
| binders | and hydraulic lime | | |
| Aggregate/ | Silica sand, dolomite, | 20-90% | 10-95% |
| lightweight | limestone, perlite, expanded | | |
| aggregates | polystyrene, cork, expanded | | |
| | vermiculite, and hollow | | |
| | glass spheres | | |
| Spray dried | Homo-, co-, or terpolymers | 0-5% | |
| resin | based on vinylacetate, | | |
| | maleic ester, ethylene, | | |
| | styrene, butadiene, versatate, | | |
| | and/or acrylic monomers | | |
| Accelerator/ | Calcium formate, sodium | 0-2% | 0-1% |
| retarder | carbonate, lithium carbonate | | |
| Fibre | Cellulose fibre, polyamide | 0-2% | 0-2% |
| | fibre, polypropylene fibre | | |
| Cellulose- | MC, MHEC, MHPC, EHEC, | 0-1% | 0-0.3% |
| ether | HEC, HMHEC | | |
| other | Air entraining agents, | 0-2% | 0-2% |
| additives | defoamers, hydrophobing | | |
| | agents, wetting agents, | | |
| | superplasticizers anti-sag | | |
| | agents, Ca-complexing agents | | |

The invention is illustrated by the following Examples. Parts and percentages are by weight, unless otherwise noted.

### EXAMPLE 1

Examples 1 and 2 show some of the chemical and physical properties of the polymers of the instant invention as compared to similar commercial polymers.

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 wt % and 2 wt %. When ascertaining the viscosity of the cellulose ether solution, the corresponding methylhydroxyalkylcellulose was used on a dry basis, i.e., the percentage moisture was compensated by a higher weight-in quantity. Viscosities of currently available, commercial methylhydroxyalkylcelluloses, which are based on purified cotton linters or high viscous wood pulps have maximum 2 wt % aqueous solution viscosity of about 70,000 to 80,000 mPas (measured using Brookfield RVT at 20° C. and 20 rpm).

In order to determine the viscosities, a Brookfield RVT rotation viscosimeter was used. All measurements at 2 wt % aqueous solutions were made at 20° C. and 20 rpm using spindle number 7.

Sodium Chloride Content

The sodium chloride content was determined by the Mohr method. 0.5 g of the product was weighed on an analytical balance and was dissolved in 150 ml of distilled water. 1 ml of 15% HNO₃ was then added after 30 minutes of stirring. Afterwards, the solution was titrated with normalized silver nitrate (AgNO₃)-solution using a commercially available apparatus.

Determination of Moisture

Moisture was measured using a commercially available moisture balance at 105°C. The moisture content was the quotient from the weight loss and the starting weight, and is expressed in percent.

Determination of Surface Tension

The surface tensions of the aqueous cellulose ether solutions were measured at 20° C. and a concentration of 0.1 wt % using a Krüss Digital-Tensiometer K10. For determination of surface tension the so-called “Wilhelmy Plate Method” was used, where a thin plate is lowered to the surface of the liquid and the downward force directed to the plate is measured.

TABLE 1
Analytical Data

| | Methoxyl/ | | | | |
|---|---|---|---|---|---|
| | Hydroxyethoxyl | Viscosity | | | |
| | or | on dry basis | | | Surface |
| | hydroxypropoxyl | at 2 wt % | at 1 wt % | Moisture | tension* |
| Sample | [%] | [mPas] | [mPas] | [%] | [mN/m] |
| RCL-MHPC | 26.6/2.9 | 95400 | 17450 | 2.33 | 35 |
| MHPC 65000 | 27.1/3.9 | 59800 | 7300 | 4.68 | 48 |
| (control) | | | | | |
| RCL-MHEC | 23.3/8.4 | 97000 | 21300 | 2.01 | 43 |
| MHEC 75000 | 22.6/8.2 | 67600 | 9050 | 2.49 | 53 |
| (control) | | | | | |

*0.1 wt % aqueous solution at 20° C.

Table 1 shows the analytical data of a methylhydroxyethylcellulose and a methylhydroxypropylcellulose derived from RCL. The results clearly indicate that these products have significantly higher visciosities than current, commercially available high viscous types. At a concentration of 2 wt %, viscosities of about 100,000 mPas were found. Because of their extremely high values, it was more reliable and easier to measure viscosities of 1 wt % aqueous solutions. At this concentration, commercially available high viscous methylhydroxyethylcelluloses and methylhydroxypropylcelluloses showed viscosities in the range of 7300 to about 9000 mPas (see Table 1). The measured values for the products based on raw cotton linters were significantly higher than the commercial materials. Moreover, it is clearly indicated by Table 1 that the cellulose ethers which are based on raw cotton linters have lower surface tensions than the control samples.

### EXAMPLE 2

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 or 2 wt %. When ascertaining the viscosity of the cellulose ether solution, the corresponding hydrophobically modified hydroxyethylcellulose was used on a dry basis, i.e., the percentage of moisture was compensated by a higher weight-in quantity.

In order to determine the viscosities, a Brookfield LVF rotation viscosimeter was used. All measurements were made at 25° C. and 30 rpm using spindles number 3 and 4, respectively.

Hydrophobically modified hydroxyethylcelluloses (HMHEC) made from purified as well as raw cofton linters were produced in Hercules' pilot plant reactor. As indicated by Table 2 both samples have about the same substitution parameters. But viscosity of the resulting HMHEC based on RCL is significantly higher.

TABLE 2
Analytical Data of HMHEC-samples

| | Viscosity | | | n-BGE | |
|---|---|---|---|---|---|
| | [mPas] | | | (n-butyl-glycidyl | Moisture |
| | 1% | 2% | HE-MS | ether) MS | [%] |
| RCL-HMHEC | 1560 | 15800 | 2.74 | 0.06 | 2.8 |
| Purified linters | 700 | 9400 | 2.82 | 0.09 | 1.3 |
| HMHEC | | | | | |

### EXAMPLE 3

All tests were conducted in a masonry mortar basic-mixture comprising of 10.00 wt % Portland Cement CEM I 42.5R, 50 wt % silica sand 0.1-0.4 mm and 40 wt % silica sand (0.5-1.0 mm).

Water Retention

Water retention was either determined according to DIN EN 18555 or the internal Hercules/Aqualon working procedure.

Hercules/Aqualon working procedure

Within 5 seconds 300 g of dry mortar were added to the corresponding amount of water (at 20° C.). After mixing the sample for 25 seconds using a kitchen handmixer, the mortar was filled into a plastic ring, which was positioned on a piece of filter paper. Between the filter paper and the plastic ring, a thin fibre fleece was placed, while the filter paper was laying on a plastic plate. The weight of the arrangement was determined before and after the mortar was filled in. Thus, the weight of the wet mortar was calculated. Moreover, the weight of the filter paper was known. After soaking the filter paper for 3 min, the weight of the filter paper was measured again. Now, the water retention [%] was calculated using the following formula:

$$WR [ \% ] = 100 - \frac{100 \times WU \times ( 1 + WF )}{WP \times WF} with$$

$$WU = water uptake of filter paper [ g ]$$

$$WF = water factor$$

$$WP = weight of plaster [ g ]$$

$$* water factor \text{:} amount of used water divided by amount of used dry$$

$$mortar , e . g . 20 g of water on 100 g of dry mortar results in a water$$

$$factor of 0.2$$

Flow, Density and Air-Content of Mortar

Flow, density and air-content of the resulting mortar were determined according to DIN EN 18555.

Methylhydroxyethylcellulose (MHEC) made from RCL was tested in a masonry mortar basic-mixture in comparison to commercially available, high viscous MHEC (from Hercules). The results are shown in Table 3.

TABLE 3
Testing of different MHECs in masonry mortar
(23° C./50% relative air humidity)

| | Masonry mortar basic-mixture | | | |
|---|---|---|---|---|
| Additives | 0.02% | 0.02% | 0.015% | 0.015% |
| (dosage on | RCL | MHEC | MHEC | RCL |
| basic- | MHEC | 75000 | 75000 | MHEC |
| mixture) | | | | |
| Water factor | 0.17 | 0.17 | 0.18 | 0.18 |
| Water retention | 80.13 | 71.24 | 64.1 | 68.95 |
| (%, DIN) | | | | |
| Flow (mm) | 142 | 143 | 147 | 144 |
| Fresh mortar | 1851 | 1904 | 1951 | 1935 |
| density (g/l) | | | | |
| Air content (%) | 13 | 11.5 | — | — |

It is shown in Table 3 that RCL-MHEC provides better water retention, when added at the same addition level as compared to the control sample: At both dosage levels, 0.02 and 0.015%, water retention was clearly higher. Flow values were slightly lower, but still comparable to those of the conventional commercial MHEC 75000 sample.

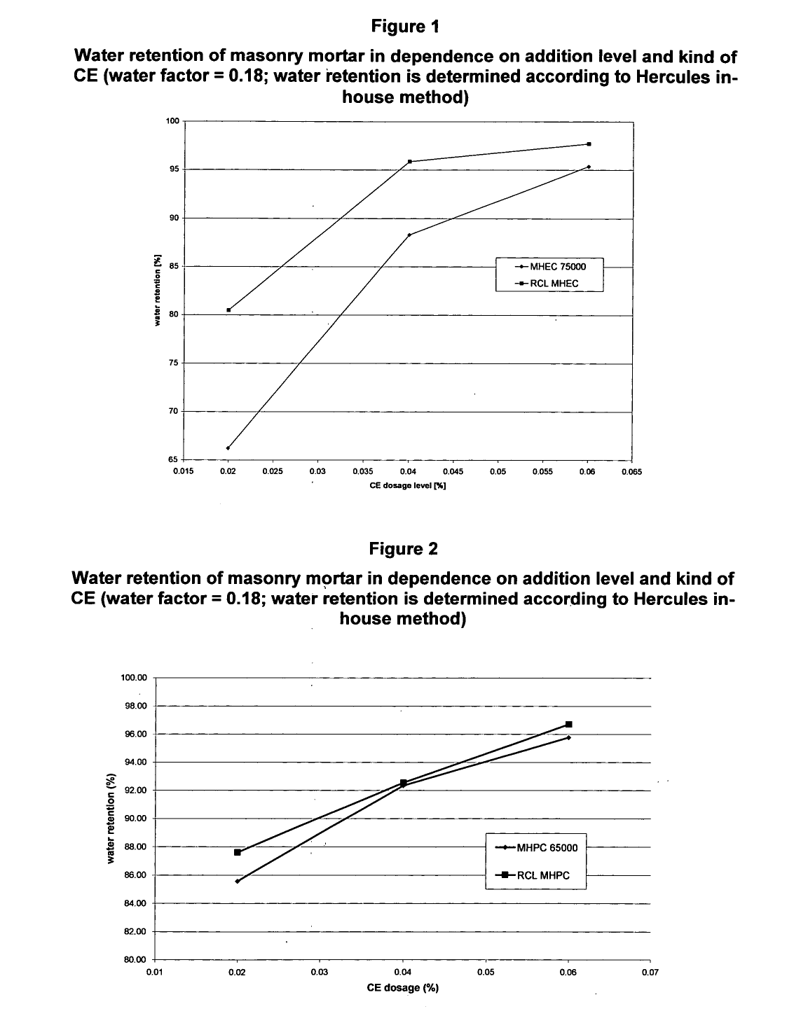

In another test series water retention of masonry mortar was determined based on CE-addition level. Again, RCL-based MHEC was compared against the control MHEC 75000 sample. FIG. 1 clearly demonstrates that RCL-based MHEC has a superior application performance with respect to water retention capability as compared to currently used very high viscosity MHEC. Especially, at a lower CE-dosage a clear advantage of the RCL-based material was seen. Here, at the same addition level higher water retention was achieved, i.e. the same water retention was reached at a significantly reduced dosage.

Thus, Table 3 and FIG. 1 clearly show that RCL-based MHEC exhibits improved application performance at the same addition level.

### EXAMPLE 4

All tests were conducted in a masonry mortar basic-mixture comprising of 10.0 wt % Portland Cement CEM I 42.5R, 50.0 wt % silica sand with particle sizes of 0.1-0.4 mm and 40 wt % silica sand (0.5-1.0 mm).

Water Retention, Flow, Density and Air-Content of Mortar

Water retention, flow, density and air-content of the wet mortar were determined as described in Example 3.

Methylhydroxypropylcellulose (MHPC) made from RCL was tested in a masonry mortar basic-mixture in comparison to commercially available, high viscosity MHPC 65000 sample (from Hercules) as the control. To all basic-mixtures an ethoxylated fatty. alcohol with 12-18 carbon atoms in the alkyl group and 20-60 ethylene oxide units of the fatty alcohol was added as air entraining agent (AEA). The results are shown in Table 4.

TABLE 4
Testing of different MHPCs in masonry mortar
(23° C./50% relative air humidity)

| | masonry mortar basic-mixture | | |
|---|---|---|---|
| Additives (dosage on | 0.04% MHPC | 0.02% MHPC | 0.02% RCL- |
| basic-mixture) | 65000 + | 65000 + | MHPC |
| | 0.01% AEA | 0.01% AEA | 0.01% AEA |
| Water factor | 0.18 | 0.18 | 0.18 |
| Water retention | 84.06 | 71.16 | 72.54 |
| (%, DIN) | | | |
| Flow (mm) | 164 | 150 | 156 |
| Fresh mortar | 1705 | 1811 | 1791 |
| density (g/l) | | | |
| Air content (%) | 20 | 15 | 15.5 |

At the same addition level of 0.02%, the control as well as the RCL-MHPC behaved quite similar. In the RCL-MHPC containing masonry mortar, an improved water retention was measured.

In another test series water retention of masonry mortar was determined based on CE-addition level. Again, RCL-based MHPC was compared with the control MHPC 65000. FIG. 2 shows an improved water retention behavior for the mortars containing RCL-MHPC.

### EXAMPLE 5

All tests were conducted in a masonry mortar basic-mixture of 10.0 wt % Portland Cement CEM I 42.5R, 50.0 wt % silica sand with particle sizes of 0.1-0.4mm, and 40.0 wt % silica sand (0.5-1.0 mm).

Water Retention, Flow, Density and Air-Content of Mortar

Water retention, flow, density and air-content of the wet mortar were determined as described in Example 3.

Methylhydroxypropylcellulose (MHPC) made from RCL was blended with polyacrylamide (PAA) (molecular weight: 8-15 million g/mol; density: 825±50 g/dm³; anionic charge: 15-50 wt %) and the blend was tested in the masonry mortar basic-mixture. The performances of this blend were compared against those of a blend of commercially available, high viscosity MHPC 60000 sample and the same PAA. The results are shown in Table 5.

TABLE 5
Testing of modified MHPCs in masonry mortar
(23° C./50% relative air humidity)

| | Masonry mortar basic-mixture | | |
|---|---|---|---|
| Additives | 98% MHPC | 98% MHPC | 98% RCL |
| | 65000 + | 65000 + | MHPC + |
| | 2% PAA | 2% PAA | 2% PAA |
| Dosage (on basic- | 0.04 | 0.02 | 0.02 |
| mixture) [%] | | | |
| Water factor | 0.19 | 0.19 | 0.19 |
| Water retention | 87.05 | 72.20 | 75.36 |
| (%, DIN) | | | |
| Flow (mm) | 152 | 148 | 144 |
| Fresh mortar | 1785 | 1911 | 1896 |
| density (g/l) | | | |
| Air content (%) | 16.5 | 12 | 12 |

The data in Table 5 clearly indicate the higher efficiency of PAA modified RCL-MHPC. When RCL-MHPC was used at the same dosage as the control sample (modified MHPC 65000), a higher water retention was measured for the resulting masonry mortar. Moreover, a stronger thickening effect was noted which was reflected in the lower flow value. Fresh mortar density and air content were comparable.

### EXAMPLE 6

All tests were conducted in a masonry mortar basic-mixture of 10.0 wt % Portland Cement CEM I 42.5R, 50.0 wt % silica sand with particle sizes of 0.1-0.4 mm and 40.0 wt % silica sand with particle sizes of 0.5-1.0 mm.

Water Retention, Flow, Density and Air-Content of Mortar

Water retention, flow, density and air-content of the wet mortar were determined as described in Example 3.

Hydrophobically modified hydroxyethylcellulose (HMHEC) made from RCL in Hercules' pilot plant was tested in masonry mortar basic-mixture in comparison to a pilot plant HMHEC, which was made from purified raw cofton linters under the same process conditions. In all tests an air entraining agent (AEA, see Example 4) was added. The results are shown in Table 6.

TABLE 6
Testing of different HMHECs in masonry mortar
(23° C./50% relative air humidity)

| | Masonry mortar basic-mixture | | |
|---|---|---|---|
| Additives (dosage on | 0.02% HMHEC | 0.02% RCL- | 0.015% RCL- |
| basic-mixture) | based on | HMHEC/ | HMHEC/ |
| | purified linters/ | 0.01% AEA | 0.01% AEA |
| | 0.01% AEA | | |
| Water factor | 0.17 | 0.17 | 0.17 |
| Water retention | 60.5 | 64.4 | 62.8 |
| (%, DIN) | | | |
| Flow (mm) | 175 | 172 | 176 |
| Fresh mortar | 1656 | 1677 | 1658 |
| density (g/l) | | | |
| Air content (%) | 19.5 | 19 | 19.5 |

Table 6 shows that RCL-MHEC provides better water retention when added at the same addition level as compared to the control sample (HMHEC purified linters). Flow values as well as fresh mortar densities and air contents show only slight differences.

Although dosage of RCL-HMHEC was reduced by 25% in comparison to the control sample, water retention of the resulting mortar was still better, whereas the other wet mortar properties were similar.

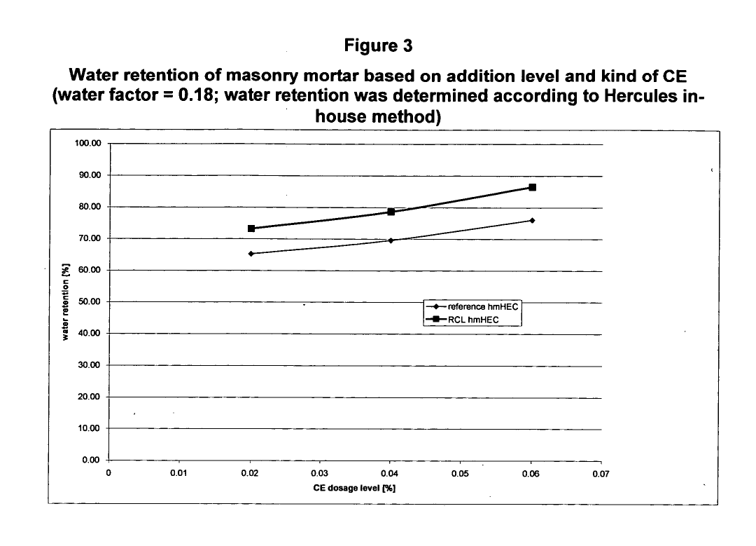

In another test series, water retention of masonry mortar was determined based on CE-addition level. Again, RCL-based HMHEC was compared with HMHEC based on purified raw cofton linters. FIG. 3 clearly demonstrates that RCL-based HMHEC has a superior application performance with respect to water retention. At the same addition level a higher water retention was achieved, i.e. the same water retention was reached at a significantly reduced dosage.

Thus, Table 6 and FIG. 3 clearly show that RCL-HMHEC exhibits similar application performance at reduced addition level as compared to the control sample.

### EXAMPLE 7

All tests were conducted in a thin joint mortar basic-mixture of 40.00 wt % Portland Cement CEM I 42.5R (white), 49.25 wt % silica sand with particle sizes of 0.1-0.3 mm, 10.00 wt % limestone (particle sizes<0.15mm), 0.5 wt % spray dried resin, and 0.25 wt % of cellulose ether.

Flow of Mortar/Spreading

Flow of the resulting mortar was determined according to DIN EN 18555.

Density of Mortar

Density of mortar was determined according to DIN EN 1015. The freshly prepared mortar was filled precisely into a 1 dm³ container and put on a balance for wet density calculation.

Open Time

Open time of mortar was determined according to DIN EN 1015. For open time determination limestone bricks (5×11.5×24 cm) were used as substrate. On this substrate a mortar layer of 2-3 mm thickness of mortar was applied. Every 3 min, a smaller limestone brick (size: 5×5 cm) was imbedded in the mortar bed by loading with a weight. The weight depends on the mortar density (density <1 kg/I=>weight 0.5 kg/density >1 kg/l=>weight 1.2 kg/l).

Open time was finished, when less than 50% of the smaller limestone brick was covered with mortar.

Setting Behavior

Setting behavior of the investigated thin joint mortars was investigated in accordance to DIN EN 196-3 using a Vicat needle device. The freshly prepared mortar was filled into a ring and a needle was dropped down and penetrated the mortar for as long as plasticity allowed. During setting/hardening of the mortar, penetration decreased. The beginning and ending of the penetrations were defined in hours and minutes according to a certain penetration in millimeter.

Methylhydroxyethylcellulose (MHEC) and methylhydroxypropylcellulose (MHPC) made from RCL were tested in the above-mentioned thin joint mortar composition in comparison to commercially available, high viscous MHEC and MHPC (from Hercules) as controls. The results are shown in Table 7.

TABLE 7
Testing of different cellulose ethers in thin joint mortar
application (23° C./50% relative air humidity)

| | Dosage (on | | | | | | | | |
|---|---|---|---|---|---|---|---|---|---|
| | basic- | | | Spreading | | | | Setting time | |
| | mixture) | | Density | [mm] | | | Open time | [h] | |
| | [wt %] | WF | [kg/l] | direct | after 2 h | after 4 h | [min] | initial | final |
| MHPC 65000 | 0.25 | 0.28 | 1.72 | 160 | 172 | 166 | 15 | 8 | 10 |
| MHPC 65000 | 0.22 | 0.275 | 1.71 | 162 | 174 | 170 | 12 | 8 | 9 |
| RCL-MHPC | 0.22 | 0.29 | 1.68 | 158 | 173 | 167 | 13 | 8 | 10 |
| MHEC 75000 | 0.25 | 0.28 | 1.72 | 157 | 169 | 162 | 17 | 9 | 11 |
| MHEC 75000 | 0.22 | 0.275 | 1.70 | 160 | 168 | 165 | 14 | 9 | 10 |
| RCL-MHEC | 0.22 | 0.305 | 1.65 | 158 | 165 | 170 | 18 | 10 | 12 |

As shown in Table 7, both of the RCL-based products were tested at a 12 % lower addition level as compared to the control high viscosity types. In all tests, consistency of the resulting mortar was adjusted to a spreading value of about 160 mm. Despite the low dosage levels, water demand for the thin joint mortars containing RCL-CE was higher than that of the control methylhydroxyalkylcelluloses, i.e. the RCL-samples had a stronger thickening effect than the controls.

When MHPC 65000 and MHEC 75000 were tested at reduced dosage, the resulting thin joint mortars showed worse application behavior with respect to open time than the mortars which contained RCL-CEs.

### EXAMPLE 8

All tests were conducted in a thin joint mortar basic-mixture of 40.00 wt % Portland Cement CEM I 42.5R (white), 49.25 wt % silica sand with particle sizes of 0.1-0.3 mm, 10.00 wt % limestone (<0.15 mm), 0.5 wt % spray dried resin, and 0.25 wt % of cellulose ether.

Flow of Mortar/Spreading, Density of Mortar, Open Time and Setting Behavior

Flow of mortar/spreading, density of mortar, open time and setting behavior were determined as described in Example 7.

Methylhydroxyethylcellulose (MHEC) and methylhydroxypropylcellulose (MHPC) made from RCL were blended with polyacrylamide (PM; for details of PAA see Example 5) and tested in the thin joint mortar basic-mixture in comparison to the controls, high viscous MHEC and MHPC, respectively, which were modified accordingly. The results are shown in Table 8.

TABLE 8
Testing of different modified cellulose ethers in thin joint
mortar application (23° C./50% relative air humidity)

| | Dosage (on basic- | | | Spreading | | | Open | Setting time | |
|---|---|---|---|---|---|---|---|---|---|
| | mixture) | | Density | [mm] | | | time | [h] | |
| | [wt %] | WF | [kg/l] | direct | after 2 h | after 4 h | [min] | initial | final |
| 99.5% MHPC | 0.25 | 0.29 | 1.70 | 157 | 165 | 160 | 13 | 13 | 16 |
| 65000 + 0.5% PAA | | | | | | | | | |
| 99.5% MHPC | 0.22 | 0.285 | 1.72 | 160 | 167 | 164 | 11 | 12 | 15 |
| 65000 + 0.5% PAA | | | | | | | | | |
| 99.5% RCL- | 0.22 | 0.30 | 1.67 | 156 | 164 | 162 | 12 | 12 | 15 |
| MHPC + 0.5% PAA | | | | | | | | | |
| 99.5% MHEC | 0.25 | 0.29 | 1.71 | 155 | 163 | 165 | 14 | 13 | 16 |
| 75000 + 0.5% PAA | | | | | | | | | |
| 99.5% MHEC | 0.22 | 0.285 | 1.70 | 157 | 165 | 163 | 12 | 12 | 15 |
| 75000 + 0.5% PAA | | | | | | | | | |
| 99.5% RCL- | 0.22 | 0.315 | 1.68 | 158 | 160 | 164 | 17 | 14 | 16 |
| MHEC + 0.5% PAA | | | | | | | | | |

Again, consistency of the resulting mortar was adjusted to a spreading value of about 160 mm. Table 8 shows that both RCL-based products have a much stronger thickening effect on the resulting mortar than the control samples. Even at reduced dosage levels water demand was strongly increased. Moreover, the resulting mortars have open times which are comparable (for RCL-MHPC) or even longer (for RCL-MHEC) than the open times which were measured for the corresponding controls at “typical” (0.25 wt %) addition level. Densities of the RCL-CE containing mortars were slightly lower, whereas spreading values after 2 and 4 hours as well as setting times were comparable.

Although the invention has been described with referenced to preferred embodiments, it is to be understood that variations and modifications in form and detail thereof may be made without departing from the spirit and scope of the claimed invention. Such variations and modifications are to be considered within the purview and scope of the claims appended hereto.

1. A mixture composition for use in cement-based dry mortars comprising
a) a cellulose either in an amount of 20 to 99.9 wt % selected from the group consisting of alkylhydroxyalkyl celluloses, hydroxyalkyl celluloses, and mixtures thereof, prepared from raw cotton linters, and
b) at least one additive in an amount of 0.1 to 80 wt % selected form the group consisting of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres,
wherein the mixture composition, when is used in a cement based masonry mortar formulation and mixed with a sufficient amount of water, the formulation will produce a masonry or thin joint mortar, that can be applied to substrates, wherein the amount of the mixture in the mortar is significantly reduced while water retention, thickening behavior and/or sag resistance of the wet mortar are improved or comparable as compared to when using conventional similar cellulose ethers.

2. The mixture composition of claim 1 wherein the alkyl group of the alkylhydroxyalkyl cellulose has 1 to 24 carbon atoms, and the hydroxyalkyl group has 2 to 4 carbon atoms.

3. The mixture composition of claim 1 wherein the cellulose ether is selected from the group consisting of methylhydroxyethylcelluloses (MHEC), methylhydroxypropylcelluloses (MHPC), hydroxyethylcellulose (HEC), ethylhydroxyethylcelluloses (EHEC), methylethylhydroxyethylcelluloses (MEHEC), hydrophobically modified ethylhydroxyethylcelluloses (HMEHEC), hydrophobically modified hydroxyethylcelluloses (HMHEC) and mixtures thereof.

4. The mixture composition of claim 1, wherein the mixture also comprises one or more conventional cellulose ethers selected from the group consisting of methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

5. The mixture composition of claim 1, wherein the amount of the cellulose ether is 70 to 99 wt %.

6. The mixture composition of claim 1, wherein the amount of the at least one additive is 0.5 to 30 wt %.

7. The mixture composition of claim 1, wherein the at least one additive is an organic thickening agent selected from the group consisting of polysaccharides.

8. The mixture composition of claim 7, wherein the polysaccharides are selected from the group consisting of starch ether, starch, guar/guar derivatives, dextran, chitin, chitosan, xylan, xanthan gum, welan gum, gellan gum, mannan, galactan, glucan, arabinoxylan, alginate, and cellulose fibres.

9. The mixture composition of claim 1, wherein the at least one additive is selected from the group consisting of homo- or co- polymers of acrylamide, gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

10. The mixture composition of claim 1, wherein the at least one additive is selected from the group consisting of calcium chelating agents, fruit acids, and surface active agents.

11. The mixture composition of claim 1, wherein the significantly reduced amount of the mixture used in the mortar is at least 5% reduction.

12. The mixture composition of claim 1, wherein the significantly reduced amount of the mixture used in the mortar is at least 10% reduction.

13. The mixture composition of claim 4, wherein the mixture composition is MHEC or MHPC and an additive selected from the group consisting of homo- or co- polymers of acrylamide, starch ether, a superplasticizer, and a mixture thereof.

14. The mixture composition of claim 13, wherein the co-polyacrylamide is selected from the group consisting of poly(acrylamide-co-sodium-acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyidimethylammonium chloride), poly(acrylamide-co-(acryloylamino)propyltrimethylammoniumchloride), poly(acrylamide-co-(acryloyl)ethyltrimethylammoniumchloride), and mixtures thereof.

15. The mixture composition of claim 13, wherein the starch ether is selected from the group consisting of hydroxyalkylstarches where the alkyl group has 1 to 4 carbon atoms, carboxymethylated starch ethers, and mixtures thereof.

16. The mixture composition of claim 13, wherein the superplasticizer is selected from the group consisting casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, and mixtures thereof.

17. The mixture composition of claim 4, is HMHEC and an additive selected from the group consisting of polyacrylamide, starch ether, superplasticizer, and mixtures thereof.

18. A cement-based dry mortar composition comprising hydraulic cement, fine aggregate material, and a water-retaining agent of at least one cellulose ether prepared from raw cotton linters,
wherein when the cement based dry mortar composition is mixed with a sufficient amount of water, the dry mortar composition produces a wet masonry or thin joint mortar, which can be applied on substrates, where the amount of the cellulose ether in the masonry mortar or thin joint mortar is significantly reduced while water retention, thickening behavior, and/or sag resistance of the wet mortar are comparable or improved as compared to when using conventional similar cellulose ethers.

19. The cement based dry mortar composition of claim 18, wherein the at least one cellulose ether is selected from the group consisting of alkylhydroxyalkyl celluloses and hydroxyalkyl celluloses and mixtures thereof, prepared from raw cotton linters.

20. The cement based dry mortar composition of claim 19, wherein the alkyl group of the alkylhydroxyalkyl celluloses has 1 to 24 carbon atoms and the hydroxyalkyl group has 2 to 4 carbon atoms.

21. The cement-based dry mortar composition of claim 18, wherein the cellulose ether is selected from the group consisting of methylhydroxyethylcelluloses(MHEC), methylhydroxypropylcelluloses(MHPC), methylethylhydroxyethylcelluloses(MEHEC), ethylhydroxyethylcelluloses(EHEC), hydrophobically modified ethylhydroxyethylcelluloses(HMEHEC), hydroxyethylcelluloses(HEC), hydrophobically modified hydroxyethylcelluloses(HMHEC), and mixtures thereof.

22. The cement-based dry mortar composition of claim 21, wherein the cellulose ether, where applicable, has a methyl or ethyl degree of substitution of 0.5 to 2.5, hydroxyethyl or hydroxypropyl molar substitution (MS) of 0.01 to 6, and molar substitution (MS) of the hydrophobic substituents of 0.01-0.5 per anhydroglucose unit.

23. The mixture composition of claim 18, wherein the mixture also comprises one or more conventional cellulose ethers selected from the group consisting of methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

24. The cement-based dry mortar composition of claim 18, wherein the amount of cellulose ether is between 0.001 and 1.0 wt %.

25. The cement-based dry mortar composition of claim 18 in combination with one or more additives selected from the group consisting of organic or inorganic thickening agents, anti-sag agents, air entraining agents, wetting agents, defoamers, dispersants, calcium-complexing agents, retarders, accelerators, water repellants, redispersible powders, biopolymers, and fibres.

26. The cement-based dry mortar composition of claim 25, wherein the one or more additives are organic thickening agents selected from the group consisting of polysaccharides.

27. The cement-based dry mortar composition of claim 26, wherein the polysaccharides are selected from the group consisting of starch ether, starch, guar, guar derivatives, dextran, chitin, chitosan, xylan, xanthan gum, welan gum, gellan gum, mannan, galactan, glucan, arabinoxylan, alginate, and cellulose fibres.

28. The cement-based dry mortar composition of claim 25, wherein the one or more additives are selected from the group consisting of polyacrylamide, gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylateether, polystyrene sulphonates, fruit acids, phosphates, phosphonates, , calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

29. The cement-based dry mortar composition of claim 25, wherein the amount of the one or more additives is between 0.0001 and 20 wt %.

30. The cement-based dry mortar composition of claim 18, wherein the fine aggregate material is selected from the group consisting of silica sand, dolomite, limestone, lightweight aggregates, rubber crumbs, and fly ash.

31. The cement-based dry mortar composition of claim 30, wherein the lightweight aggregates are selected from the group consisting of perlite, expanded polystyrene, cork, expanded vermiculite, and hollow glass spheres.

32. The cement-based dry mortar composition of claim 30, wherein the fine aggregate material is present in the amount of 10-95 wt %.

33. The cement-based dry mortar composition of claim 30, wherein the fine aggregate material is present in the amount of 40-90 wt %.

34. The cement-based dry mortar composition of claim 18, wherein the hydraulic cement is selected from the group consisting of Portland cement, Portland-slag cement, Portland-silica fume cement, Portland-pozzolana cement, Portland-burnt shale cement, Portland-limestone cement, Portland-composite cement, blastfurnace cement, pozzolana cement, composite cement and calcium aluminate cement.

35. The cement-based dry mortar composition of claim 18, wherein the hydraulic cement is present in the amount of 4-60 wt %.

36. The cement-based dry mortar composition of claim 18, wherein the hydraulic cement is present in the amount of 10-40 wt %.

37. The cement-based dry mortar composition of claim 18 in combination with at least one other mineral binder selected from the group consisting of hydrated lime, gypsum, puzzolana, blast furnace slag, and hydraulic lime.

38. The cement-based dry mortar composition of claim 37, wherein the at least one mineral binder is present in the amount of 0.1-30 wt %.

39. The cement based dry mortar composition of claim 18, wherein the significantly reduced amount of the cellulose ether used in the cement based dry mortar composition is at least 5% reduction.

40. The cement based dry mortar composition of claim 18, wherein the significantly reduced amount of the cellulose ether used in the cement based dry mortar composition is at least 10% reduction.

41. The cement based dry mortar composition of claim 21, wherein the cellulose ether is MHEC or MHPC and has an aqueous Brookfield solution viscosity of greater than 80,000 mPas as measured on a Brookfield RVT viscometer at 2 wt %, 20° C., and 20 rpm using spindle number 7.

42. The cement based dry mortar composition of claim 21, wherein the cellulose ether is MHEC or MHPC and has an aqueous Brookfield solution viscosity of greater than 90,000 mPas as measured on a Brookfield RVT viscometer at 2 wt %, 20° C., and 20 rpm using spindle number 7.
